(19) United States
(12) Patent Application Publication
(10) Pub. No.: US 2007/0097792 A1
(43) Pub. Date: May 3, 2007

(54) System of increasing outpatient medication compliance using reminder devices attached to containers at point of filing and associated methods

(75) Inventors: Mark Burrows, Newton, PA (US); Mark Ramberg, Bellevue, WA (US)

Correspondence Address: Mark Burrows, 1237 Liberty Drive, Newton, PA, 18940, US

(73) Assignee: Inflection Point

(21) Appl. No.: 11/264,249

(22) Filed: Nov. 1, 2005

(51) Int. Cl. G04B 47/00

(52) U.S. Cl. 368/10

(57) ABSTRACT

The present invention is a method of continuously increasing patient compliance with medication dosing regimen that does not rely on incremental effort, investment, and/or other patient resource. The method includes uploading compliance data from one or more electronically enhanced containers to a database, analyzing said uploaded compliance data, generating one or more patient specific compliance reports from said database, and reporting said one or more patient specific compliance reports to one or more stakeholders.

### CROSS REFERENCE TO RELATED CO-PENDING APPLICATIONS

This application claims the benefit of, and expressly incorporates herein by reference, the entire disclosures of the following U.S. patent applications:
U.S. patent application No. ______ (SP-100), entitled SYSTEM OF INCREASING OUTPATIENT MEDICATION COMPLIANCE USING ELECTRONICALLY ENHANCED CONTAINER AND ASSOCIATED METHODS, filed Nov. 2, 2005, which in turn claims priority to U.S. Patent Application No. 60/624,433, entitled SYSTEM OF INCREASING OUTPATIENT MEDICATION COMPLIANCE USING ELECTRONICALLY ENHANCED CONTAINER AND ASSOCIATED METHODS, filed Nov. 2, 2004;

### FIELD OF THE INVENTION

The present invention relates to improving health care, specifically to reducing patients' lifetime health care cost and improving patients' quality of life by increasing outpatient medication compliance with dosing regimens.

### BACKGROUND OF THE INVENTION

Outpatient prescription medication treatments are relied upon so heavily for increased quality of life and lower lifetime healthcare costs that $307 billion is spent each year globally for such medication; more than half, or $160 billion, is spent in the U.S. alone, according to IMS Health.

The International Society for Pharmacoeconomics and Outcomes Research (ISPOR) Medication Compliance Special Interest Group (Med Comp) states as its objective “To stimulate research and evaluation on issues related to medication compliance, treatment persistence, and implications for health outcomes.” ISPOR Med Comp defines medication compliance/adherence as “the extent to which a patient acts in accordance with the prescribed interval and dose of a treatment regimen, measured by percentage of doses taken properly.” ISPOR defines medication persistence as “the accumulation of time from initiation to discontinuation of medication therapy, measured in time.”

Medical experts have long held that taking at least 80% of a prescribed drug is required to achieve desired therapeutic outcomes and lower lifetime healthcare costs. For example, a patient who faithfully takes cholesterol-reducing medicine significantly reduces the likelihood of a coronary event with attendant cost-intensive medical procedures and diminished quality of life. Outpatients strongly desire to avoid such events and hospital stays, yet only 20% of all outpatients take their prescription medicines according to doctor's instructions. Four out of five do not, as documented by the Healthcare Compliance Packaging Council Task Force Report of 1993. That report and other industry sources calculate average patient compliance with prescription-medicine dosing regimens at 50%. It further documents that 15% of patients don't even fill prescriptions, 14% fill prescriptions but don't take any doses, 22% take less than prescribed, and 29% stop before finishing the prescription.

In consequence are otherwise unnecessary hospital admissions at a cost of between $31 billion and $100 billion annually, estimated by the Schering Report IX called “The Forgetful Patient: The High Cost of Improper Patient Compliance” and MedAdvisor, Inc., respectively. According to studies referenced in Compliance Packaging: A Patient Education Tool (D. Smith, American Pharmacy, Vol. NS29, No. 2 February 1989) medication non-compliance causes 125,000 deaths annually.

The economic impact of non-compliance is large and increasing. L. R. Standberg reports in Drugs as a Reason for Nursing Home Admissions (American Health Care Association Journal, 10,20 (1984)) that 23% of nursing home admissions are due to medication non-compliance. The cost was estimated at $31.3 billion/380,000 patients. In the Oregon Department of Human Resources publication, A Study of Long-Tern Care in Oregon with Emphasis on the Elderly (March 1981), it was reported that 10% of all hospital admissions where due to medication non-compliance. With the aging population in the United States, it is reasonable to expect that this problem will only get worse.

Pharmaceutical manufacturers also stand to gain from increased outpatient medication compliance in the form of increased medication sales. Accordingly, these manufacturers are actively investing in and testing compliance-increase techniques. A marketing executive at one major Pharma company said that his market research documented that patients want to comply, but will not take on the burden of any additional actions or otherwise change behavior. To help determine which mechanisms were successful in increasing patient compliance, this executive also said he'd pay $10 per months for each of 10,000 patients' dosing data. Pharmaceutical manufacturers GlaxoSmithkline, AstraZeneca, Bristol Myers-Squibb, and Lilly were among 11 pharmaceutical companies with director/manager-level delegates attending Center for Business Intelligence's “First Ever Forum on Patient Compliance,” Apr. 11 & 12, 2002 in Philadelphia. CBI's “Third Annual Forum on Patient Compliance and Persistency” was held with a larger group Apr. 19 & 20, 2004.

At the 2002 Forum on Patient Compliance, Robin Lugar, MSW, ACSW, Ph.D. candidate at Indiana State University, presented findings of her patient-compliance literature compilation and analysis from 1974 to 2000 in which she identified 11 discrete theories and drew four salient conclusions. Conclusion one: “There is no consistent theoretical model for prediction of non-compliance.” Conclusion two: “Subjective measures of patient and physician report overestimate compliance.” Conclusion three: “Medication taking was based on how well the regimen fit into daily life.” Conclusion four: “Because of lack of consistency in research findings, it might be fruitful to investigate several factors simultaneously.”

As to factors causing non-compliance, authors of Facilitating Treatment Adherence, Donald Meichenbaum of the University of Waterloo, Ontario, and Dennis C. Turk, University of Pittsburgh School of Medicine, cited a compliance study published in 1978 by Epstein & Masek in which 193 factors affecting patient compliance were examined at least 10 times. Four of the 193 factors had direct correlation with compliance level in more than half the studies: patient satisfaction with treatment results, long-term (chronic) therapy, paucity of information from doctors, and burdening patients to change behaviors.

Even so, a number of current compliance-improvement techniques rely on changing patient behavior, e.g., HealthMedia, ScriptAssist, Epotech, and Xceleron. All relied on reminders via postal mail or telephone to encourage patients to increase compliance. Affirming Epstein & Masek's 1978 findings, Ohio State University professor of emergency medicine, Robert Guthrie, concluded in 2003 from a study of 4,548 patients that such behavior-change tactics don't work. The study, sponsored by Bristol Myers-Squibb and published in the summer 2003 journal of Clinical Therapeutics, caused Dr. Guthrie to conclude that “According to patients, the telephone and postal reminders did very little to improve their compliance,” he said. “Health care providers, third-party payers, and health care policy-makers should take note that these costly extra measures to ensure compliance don't appear to have an effect.”

In fact, such reminders have been known to backfire. In July 2005, a director in clinical trials at GlaxoSmithKline cited a study he knew of in which these reminders annoyed patients to the degree that they intentionally did not take their medications as directed.

However, electronic packages have proven effective. In one 1992 study with an anti-hypertensive treatment, control group compliance was the expected 50% while the test group was 92% compliant via use of an electronic packaging device, called PreScript TimeCap. In the 70-patient study by Jackson T. Wright Jr., M.D., Ph.D. et al., called Impact of an Electronic Medication Compliance Aid on Long-Term Blood Pressure Control (Journal of Clinical Pharmacology, 1992:32:277-283) the authors cited the electronic package as increasing compliance, then in turn cited the increased compliance as improving the therapeutic outcome, in stating that “The most impressive finding was the clinically significant lowering of blood pressure.”

In a focus group evaluation of an electronic-reminder medication package, four cardiologists with Cardiovascular Healthcare Consultants, P.C. of Paoli, Pa. in November 2001 said that medication compliance is so important that, among two or three equivalent drugs, they would specify the drug whose package fosters higher patient compliance. The example given was three competing cholesterol-lowering medications. It's well known by cardiologists and their patients that cardiovascular disease is the leading cause of death in the Western world.

Numerous other packaging devices and adjuncts have been available for many years ranging from inexpensive tablet boxes with a compartment for each day of the week, into which patients may decant meds from pharmacy containers, to expensive Aprex electronic reminder/monitoring devices. In the study Microelctronic Systems for Monitoring and Enhancing Patient Compliance with Medication Regimens (Cramer, J. A, Drugs, 49: 321-7 (1995)) the author concludes that patients are simply unaware of their own level of medication compliance, making changes in behavior difficult. “Many people who take medications long term have neither any concept of how poorly they comply nor thoughts about how to enhance compliance by developing special tactics to remember dose times,” Cramer says. “The potential gains in improved self-care of individual patients are well worth the cost of monitoring devices.”

Irrespective of cost, no device has gained wide acceptance because all rely on changing patient behavior to suit the medication, whether in the form of decanting or remembering to push an event button to reset electronics, rather than changing medication conveyance to suit patients. What is needed is a mechanism which requires no additional action of or cost to patients to improve their compliance by incorporating reminder apparatus and its programming in the medicine supply chain.

It is therefore an object of this invention to provide a system for and methods of increasing medication compliance in a manner that outpatients prefer, i.e. with no need to change their behavior or spend more of their money.

It is a further object of this invention to provide a system for and methods of incorporating integral reminder apparatus in the medication supply chain.

It is a further object of this invention to continually increase patients' compliance with medication dosing regimens by optimizing type of reminder signal for specific patient segments based on compliance data collected from returned containers.

Further objects and advantages of this invention will become apparent from the figures and related description.

### SUMMARY OF THE INVENTION

The present invention is a method of continuously increasing patient compliance with medication dosing regimen that does not rely on incremental effort, investment, and/or other patient resource. The method includes uploading compliance data from one or more electronically enhanced containers to a database, analyzing said uploaded compliance data, generating one or more patient specific compliance reports from said database, and reporting said one or more patient specific compliance reports to one or more stakeholders. The compliance data may include one of the following: frequency, date or time of daily dose dispensing. The analysis may also include one of the following: level of patient compliance, effectiveness of a specific reminder type; and the analysis may result in a recommendation for a specific type of the reminder type. The reminder types may include one or more or, a combination of the following: audible, visual, or tactile. Compliance data is preferably accumulated in a compliance data registry; where the compliance data registry may include one or more of the following: treatment outcomes relative to compliance, or data on effectiveness of reminder type for various patients. The stakeholders may include one or more of the following: a Patient, a Medical Professional, a Health Insurance Company, a Pharmaceutical Manufacturers, a Caregiver, or a Hospital. The patient specific compliance reports may include one or more of the following: patient name, medication name, doctor's name, report date, reminder time, date and time of container opening and closing, double dose attempts, percent compliance.

The invention further includes a method of measuring return on investment in increasing patient compliance using compliance reminder signaling devices and related methods, and/or other reminder methods. The method includes generating a patient specific compliance report, reporting the patient specific compliance report to one or more stakeholders, determining if patient compliance increase target has been achieved, optimizing type of the reminder signal device if the patient compliance increase target has not been achieved, and documenting return on increased compliance. The Pharmaceutical Manufacturer preferably analyzes the patient compliance report to inform decisions regarding financial investments into increasing patient compliance. Determining if patient compliance increase target has been achieved includes seeing whether the anticipated compliance increase achieves a specific target increase. Optimizing type of the reminder signal device may include analyzing the patient specific compliance report for effectiveness of different types of the reminder signal devices for various patient group lifestyles, and adjusting the reminder type to the patient group lifestyle.

### BRIEF DESCRIPTION OF THE DRAWINGS

FIG. 1 shows a conventional medication dispensing and monitoring system.

FIG. 2 shows a conventional medication dispensing and monitoring system using a programmed reminder device.

FIG. 3 illustrates a system for increasing outpatient patient compliance with a dosing regimen.

FIG. 4 shows a method for increasing patient compliance with a dosing regimen.

FIG. 5 shows a method for medication distribution.

FIG. 6 shows details of a method for increasing patient compliance to a dosing regimen.

FIG. 7 shows a method of determining the level of patient compliance with a dosing regimen.

FIG. 8 shows a method of determining return on investment in compliance reminder signaling devices and methods.

FIG. 9 shows a sample report on an individual's compliance with medication dosing regimen.

FIG. 10 shows the sample report of FIG. 9 with illustrative data.

### DETAILED DESCRIPTION OF THE INVENTION

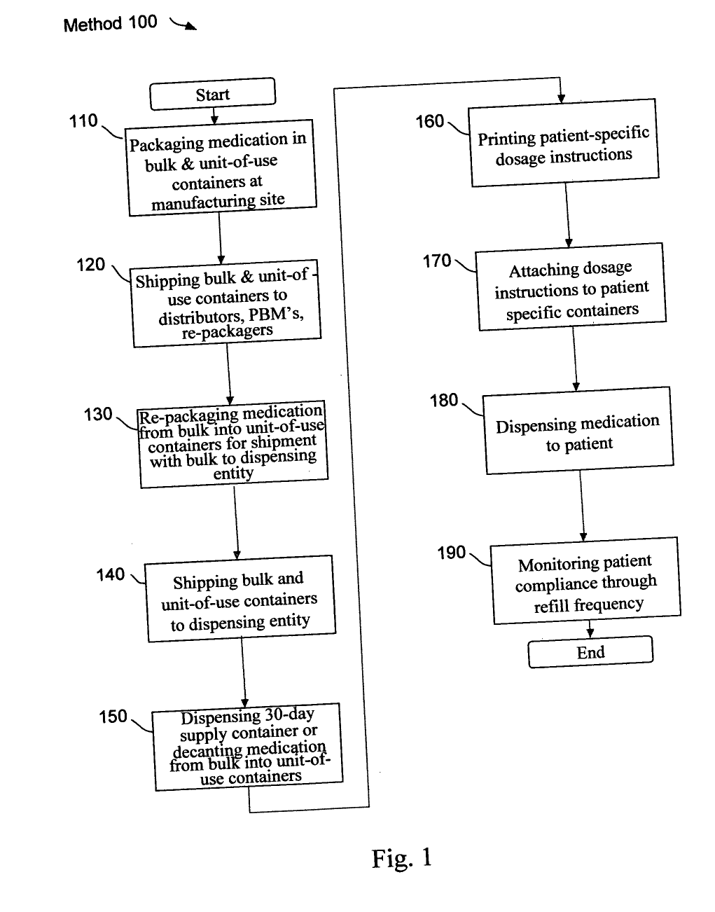

FIG. 1 illustrates Method 100, which describes a conventional medication dispensing and monitoring process and includes the following steps:

Step 110 Packaging medication in bulk containers and unit-of use containers at a manufacturing site.

In Step 110, medication is packaged at the manufacturer in bulk containers (usually 90 to 5,000 tablets or capsules) and in some cases, unit-of-use containers, usually one month's supply, for shipment to distributors, pharmacy benefit managers (PBM's) and re-packagers. Method 100 proceeds to Step 120.

Step 120 Shipping bulk containers and unit-of-use containers to distributors, PBM's and re-packagers

In Step 120, medication in bulk containers and in unit-of-use containers is shipped to distributors, PBM's, and re-packagers. Method 100 proceeds to Step 130.

Step 130 Packaging Medication for Shipment to Dispensing Entity

In Step 130, distributors, PBM's, and re-packagers may re-package from bulk containers into smaller containers, including unit-of-use containers, to fill specific dispensing entity orders. Method 100 proceeds to Step 140.

Step 140 Shipping Containers to Dispensing Entity

In Step 140, re-packaged containers and manufacturer-packaged containers are shipped to the dispensing entity e.g. a pharmacy chain. Method 100 proceeds to Step 150.

Step 150 Dispensing Unit-of-use Containers or Decanting Medication from Bulk Containers into Patient-specific Containers

In Step 150, Dispensing entity personnel dispense unit-of-use either from unit-of-use containers filled upstream, if available, or by decanting from larger containers into a container specific to the patient's dosing regimen, usually once daily in a unit-of-use container. Method 100 proceeds to Step 160.

Step 160 Printing patient-specific-dosage instructions.

In Step 160, dispensing entity automatically or manually prints patient-specific dosage instructions on a label suitable for attachment to the container specific to the patient's dosing regimen. Method 100 proceeds to Step 170.

Step 170 Attaching dosage instructions to patient-specific containers

In Step 170, dispensing entity personnel attach the printed label produced in Step 170 to the container specific to the patient's dosing regimen. Method 100 proceeds to Step 180.

Step 180 Dispensing medication to patient

In Step 180, the filled, labeled container from Step 170 is dispensed to the patient; in some cases, such as PBM's, dispensing is via mail or other shipment method. Method 100 proceeds to Step 190.

Step 190 Monitoring patient compliance through refill frequency.

In Step 190, patient compliance to the dosage regimen may be determined indirectly through frequency of refills. Method 100 ends.

Attempts to date to increase patient compliance have involved attaching dosage-reminder devices to containers by pharmacists, patients, or patient's caregivers. These have had no perceivable impact on compliance, principally because such devices increase, rather than lessen, patients' burden in taking medication. These devices rely on patients for programming, record keeping, decanting, or pressing and event button. While variations of such devices have been around for many years, pharmacists have not been rewarded for taking the time to program and attach them and patients have not been willing to pay for and/or otherwise adopt them.

Further, pharmaceutical manufacturers have not endorsed reminder caps owing to hazards and related liabilities arising from a patient inadvertently replacing such a cap on the wrong container of different medicine with a different dosing regimen.

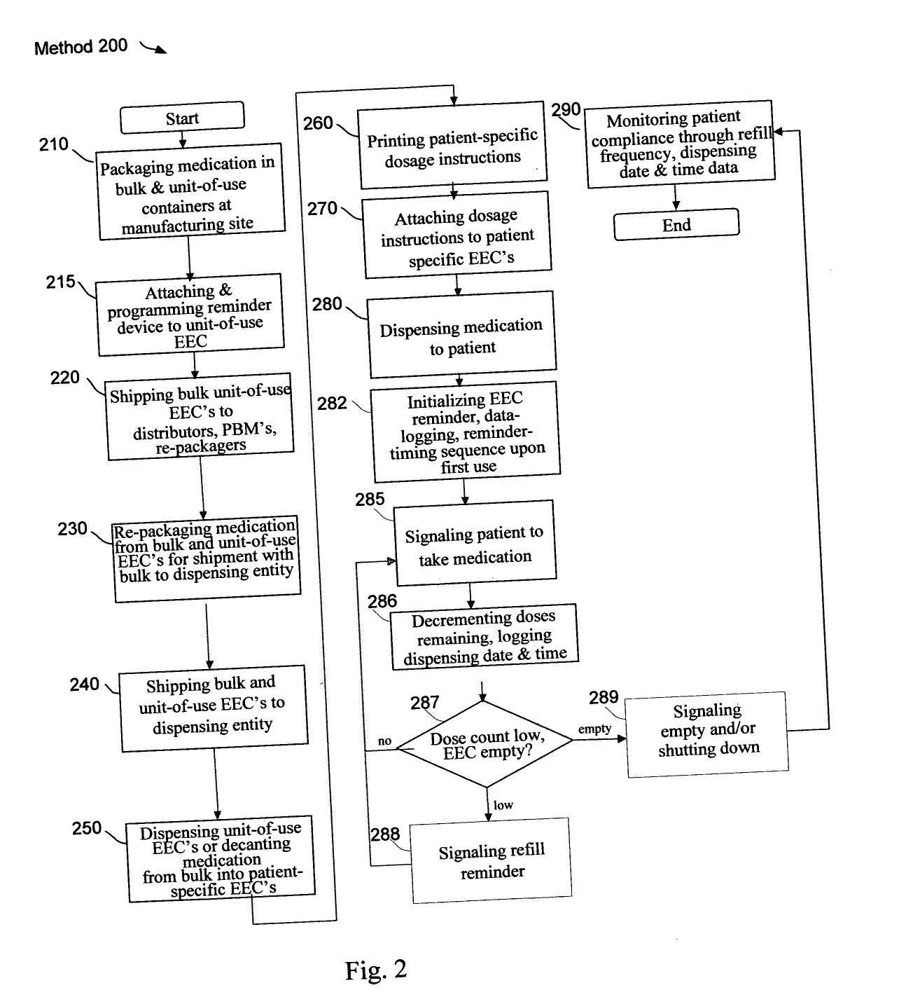

Method 200 in FIG. 2 describes a novel process for adding and programming dose-time reminder apparatus to containers of method 100 at various points of container filling in the supply chain, beginning at pharmaceutical manufacturers' container-filling lines. And includes to following steps:

Step 210 Packaging Medication in Bulk Containers and Unit-of Use Containers at Manufacturing Site.

In Step 210, medication is packaged at the manufacturer in bulk containers (usually 90 to 5,000 tablets or capsules) and in some cases, unit-of-use containers, usually one month's supply, for shipment to distributors, pharmacy benefit managers (PBM's) and re-packagers. Method 200 proceeds to Step 215.

Step 215 Attaching and Programming Reminder Devices to Unit-of-use Containers.

In Step 215, dose-time reminder apparatus is programmed via suitable programming cradles connected wired or wirelessly to manufacturers' container-filling-line PC's using a standard interface, such as universal serial bus, then attached to unit-of-use containers (EEC 305 described in Method 300 below) during filling and labeling operations using standard equipment such as a Sancoa/Wieler Outsert Placing machine modified and validated to industry and regulatory standards for this task. Pharmaceutical-packaging machinery and software engineers such as Luciano Packaging Technologies of Somerville, N.J. can readily develop, validate, and install programming and placement equipment and associated processes. Programming is set to activate the clock and memory the first time patients open the EEC 305. It should be noted that, with proper training and quality control validation that, wholesalers, PBM's, re-packagers, and retail pharmacists could become qualified perform step 215. It also should be noted that programming and/or attachment of dose-time reminder devices, including initializing reminder timing sequence in Step 282 below, may be done at separate points in the supply chain.

The dosage reminder device attached in Step 215 may be programmed for a dosing regimen, such as one or more doses per day; however, other regimens also may be programmed. Method 200 proceeds to Step 220.

Step 220 Shipping Bulk Containers and Unit-of-use EEC 305s to Distributors, PBM's and Re-packagers.

In Step 220, medication in bulk containers and in unit-of-use EEC 305s is shipped to distributors, PBM's, and re-packagers. Method 200 proceeds to Step 230.

Step 230 Re-packaging Medication from Bulk into Unit-of-use EEC 305s for Shipment with Bulk Containers to Dispensing Entity.

In Step 230, distributors, PBM's, and re-packagers may re-package from bulk containers into smaller containers, including unit-of-use EEC 305, to fill specific dispensing entity orders. Method 200 proceeds to Step 240.

Step 240 Shipping Bulk and Unit-of-use EEC 305s to Dispensing Entity

In Step 240, re-packaged EEC 305s and manufacturer-packaged EEC 305s are shipped to the dispensing entity, e.g. a pharmacy chain. Method 200 proceeds to Step 250.

Step 250 Dispensing Unit-of-use EEC 305s or Decanting Medication from Bulk Containers into Patient-specific EEC 305s

In Step 250, Dispensing entity personnel may dispense unit-of-use EEC 305's either from unit-of-use EEC 305s filled upstream, if available, or by decanting from larger containers into a container specific to the patient's dosing regimen, commonly once daily, into a unit-of-use EEC 305. Method 200 proceeds to Step 260.

Step 260 Printing Patient-specific Dosage Instructions.

In Step 260, dispensing entity manually or automatically prints patient-specific dosage instructions on a label suitable for attachment to the EEC 305 specific to the patient's dosing regimen. Method 200 proceeds to Step 270.

Step 270 Attaching Dosage Instructions to Patient-specific EEC 305s

In Step 270, dispensing entity manually or automatically may attach the printed label produced in Step 260 to the EEC 305 specific to the patient's dosing regimen. Method 200 proceeds to Step 280.

Step 280 Dispensing Medication to Patient

In Step 280, the filled, labeled EEC 305 from Step 270 is dispensed to the patient; in some cases, such as PBM's, dispensing may be via mail or other shipment method. Method 200 proceeds to Step 285.

Step 282 Initializing EEC 305 Reminder, Data-logging, Reminder-timing Sequence on First Use

In Step 282, electronics programmed in Step 215 monitors the EEC 305 closure sensor. When the patient opens the EEC 305 first time, the reminder, data-logging, and reminder timing sequence processes are initialized. Initial opening and closing of said EEC 305 occurs at the time of day patients prefer or have been directed by a licensed medical professional to take each day's first dose. Opening and/or closing may automatically decrement the dose count and may electronically log the date & time the EEC 305 was opened and closed. Method 200 proceeds to Step 285.

Step 285 Signaling Patient to Take Medication

In Step 285, EEC 305 signals patient reminder at dose time. Reminders can be of various types, including visual, audible, and textual. Method 200 proceeds to Step 286.

Step 286 Decrementing Doses Remaining, and Logging Date and Time of Dispensing.

In Step 286, opening and/or closing the container may automatically decrement the dose count and may electronically log the date & time the container was opened and closed. Method 200 proceeds to Step 287.

Step 287 Dose Count Low, Container Empty?

In step 287, a decision is made whether the dose count logged in Step 286 reaches an established threshold, e.g., when about 25% of doses remain. If no, Method 200 returns to step 285. If yes, Method 200 proceeds to Step 288. If empty, Method 200 proceeds to Step 289.

Step 288 Signaling Refill Reminder.

Step 288, reminder device signals a refill reminder; signal means may include visually, audibly, and textually. Signaling may continue until no doses remain or patient acknowledges reminder as instructed by the label. Method 200 returns to Step 285.

Step 289 Signaling Empty and/or Shutting Down.

In Step 289, the electronically stored count of remaining doses is compared to the number of doses dispensed in step 280. When the value reaches zero, no doses remain, causing EEC 305 to signal empty and/or shut down. Method 200 proceeds to Step 290.

Step 290 Monitoring Patient Compliance Through Refill Frequency and Dispensing Date & Time Data.

In step 290, patient compliance with the dosage regimen may be determined through refill activity data and by downloading date and time of dispensing data logged in Step 286. Method 200 ends.

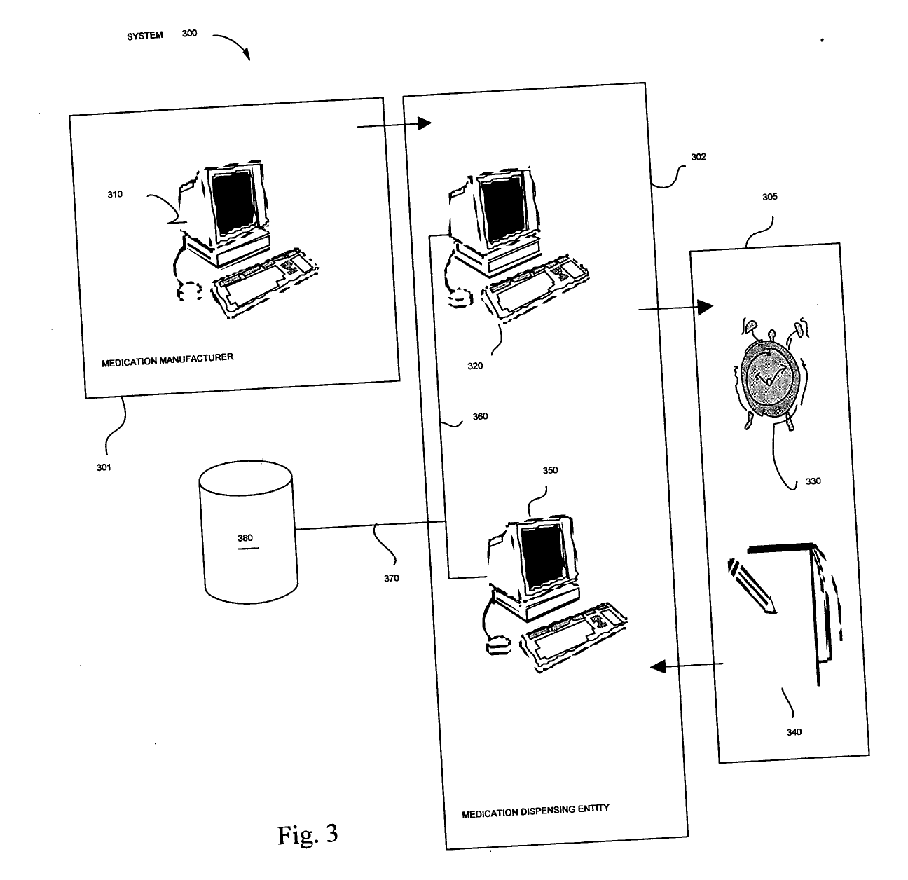

System 300 in FIG. 3 describes an example of Method 200. System 300 is a novel system which collects patient feedback on preferences and effectiveness of container reminder methods for various patient segments in order to continually improve reminder methods, in turn continually increasing compliance and therapeutic outcomes.

FIG. 3 shows system 300 for increasing outpatient medication compliance which includes medication manufacturer 301, medication dispensing entity 302, Electronically Enhanced Container (EEC) 305, container programmer 310, prescription station 320, patient reminder process 330, patient data-logging process 340, receiving station 350, data path A 360, data path B 370, and compliance database 380.

Medication manufacturer 301 is any primary medication manufacturer where prescription oral dose medication is produced and packaged for distribution to medication dispensing entities.

Medication dispensing entity 302 is any organization responsible for conveyance of medication to the patient. Types of medication dispensing entities may include pharmacies, hospitals, and dispensaries, pharmacy benefit managers (PBM), and other authorized entities, whether in person or by mail or other shipment means.

EEC 305 is a unit-of-use medication container that exhibits such functional capabilities as described in Table 1 below.

| # | Electronically Enhanced Container 305 Functional Capabilities |
|---|---|
| 1 | Consists of materials approved by responsible agencies |
| | for containing medications in tablet, capsule, |
| | or other oral dose form |
| 2 | Signals patients at dose time w/o relying on patient action |
| 3 | Automatically senses and logs date & time container |
| | is opened and closed w/o relying on patient action |
| 4 | Signals when a period's dose has been taken |
| | w/o relying on patient action |
| 5 | Memory, real-time clock, battery/other power source |
| 6 | Programmed and applied to containers at filling-line speed |
| | (without slowing the line). |
| 7 | Meets IPC reliability standards for electronics; |
| | mode of failure is to shut down |
| 8 | Meets FDA, USP container requirements |
| 9 | Accommodates child-resistant/senior friendly requirements |
| 10 | Warns when a period's dose has been taken, |
| | avoiding double dosing. |

One example of a fully functional EEC 305 is described in United States patent application no. 20020104848, Pharmaceutical container having signaling means and associated method of use, which is hereby included by reference.

Container programmer 310 is a stand-alone or PC-based electronic device capable of interfacing with EEC 305 such that the initial command set for EEC 305 may be downloaded from the container programmer 310 to EEC 305. The interface between container programmer 310 and EEC 305 may be any interface capable of reliably transferring data and may include electrical, optical, and RF. The command set may include executable software code, parameter files, and the like.

Prescription station 320 is a stand-alone or PC-based electronic device capable of interfacing with EEC 305 such that patient-specific dosing instructions and other information can be downloaded from prescription station 320 to EEC 305. The interface between prescribing station 320 and EEC 305 may be any interface capable of reliably transferring data and may include electrical, optical, and RF. Patient-specific information may include patient name, dosing schedules, special instructions such as “take with food,” prescribing licensed medical professional name, expiration date, and dispensing entity contact information.

Patient Reminding Process 330

Patient reminding process 330 is the process by which the patient is reminded to take the prescribed dose at the prescribed intervals. Patient reminding process 320 includes instructions executed on the microcontroller electronics embedded in the container EEC 305, various sensed interrupts (e.g. container opening/closing) and production of direct sensory alerts, including visual, audible, textual, etc.

Compliance Data-logging Process 340

Compliance data-logging process 340 is the process by which the level of patient compliance with the dosage regimen is recorded. Compliance data-logging process 340 includes instructions executed on the microcontroller electronics embedded in container EEC 305, various sensed interrupts (e.g. container opening/closing), and data storage (e.g., time and date of container opening and closing).

Receiving station 350 is a stand-alone or PC-based electronic device capable of interfacing with container EEC 305 such that information can be uploaded from EEC 305 to receiving station 350. Receiving station 350 may also be connected to data path A 360 and/or data path B 370. Functionality of receiving station 350 and prescribing station 320 may reside on the same hardware.

Compliance database 380 is any flat file or relational database for storing the patient compliance information downloaded from EEC 305 over Data Path B 370 and from Receiving station 350. Patient compliance data may be in anonymous form, i.e. patient identification is not included in data compilation and analysis.

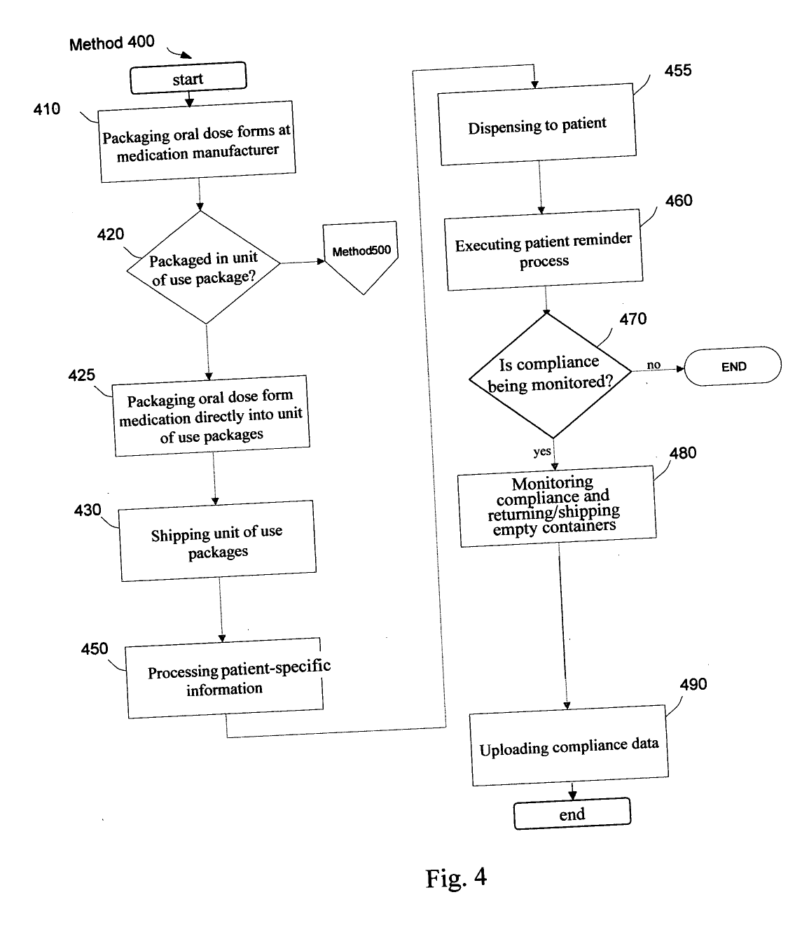

Method 400 in FIG. 4 is a detailed method of using system 300 to increase patient compliance to a dosing regimen and includes the following steps:

Step 410 Packaging Oral Dose Forms in Containers at Medication Manufacturer

In Step 410, medication in oral dose forms (e.g. tablets and capsules) is packaged in containers at manufacturer 301. Method 400 proceeds to Step 420.

Step 420 Packaged in EEC 305?

In Step 420, a decision is made whether the oral dose form is already packaged in EEC 305 30-day containers EEC 305. If the decision is yes, Step 420 proceeds to Step 425. If the decision is no, Method 400 proceeds to Method 500.

Step 425 Packaging Oral Dose Form Medication Directly into EEC 305.

In Step 425, oral dose form medication is packaged in EEC 305 and programmed, most commonly for one dose per day, however other dosing regimens also can be programmed. Method 400 proceeds to Step 430.

Step 430 Shipping Unit-of-use Containers

In Step 430, EEC 305's filled and programmed in Step 425 are shipped to wholesalers, PBM's, re-packagers, and/or dispensing entity. Method 400 proceeds to Step 450.

Step 450 Processing Patient-specific Information

In Step 450, patient-specific information may be input into prescription station 320. An EEC 305 filled with the appropriate type and number of oral dose form medication is selected and may be connected to prescription station 320 in such a manner as to allow transfer of data. Prescription station 320 establishes data communication with the selected EEC 305, performs any required checks, and downloads the patient-specific prescription information, including whether compliance data will be captured for analysis as well as for inputs such as to verify and otherwise treat dosing regimen, to the electronic memory resident on EEC 305. Method 400 proceeds to Step 455.

Step 455 Dispensing to Patient

In Step 455, the fully configured EEC 305 is physically dispensed to the patient in person, r by mail, or by other shipment means. Method 455 proceeds to Step 460.

Step 460 Executing Patient Reminder Process

In Step 460, the reminder process is initiated upon patients first opening the container at the time of day they prefer or have been directed by their licensed medical professional to dake each days'/periods' dose. Such initialization also may be done during programming in Step 450. Method 400 proceeds to Step 470.

Step 470 Is Compliance Being Monitored?

In Step 470, EEC 305 checks whether data-capture status is enabled. If yes, Method 400 proceeds to Step 480. If no, Method 400 ends.

Step 480 Monitoring Compliance and Returning/shipping Empty Containers

In Step 480, empty containers are collected for data downloading. Collection means include patient delivering the empty in person or mailing it to the dispensing entity, delivering or shipping to a designated data-collection facility in a postage-paid envelope conveyed with the EEC305, following the way in which HP supplies such envelopes for recycling spent printer cartridges. For patients, empty containers may function as a coupon for reduced (or zero) co-payment on their refill, money off other drugstore merchandise, etc. Other patient incentives may include reduction in health insurance premiums. Method 400 proceeds to Step 490.

Step 490 Uploading Compliance Data

In Step 490, data is read from empty EES 305 such as at the point of receipt of the empty container and/or a central data-collection facility to which the container has been relayed from the point of receipt. A stand-alone or PC-based electronic device such as a cradle or wand reads the empty container's data by electrical contact or wirelessly may then relay the data to a central database for logging and analysis. Method 400 ends.

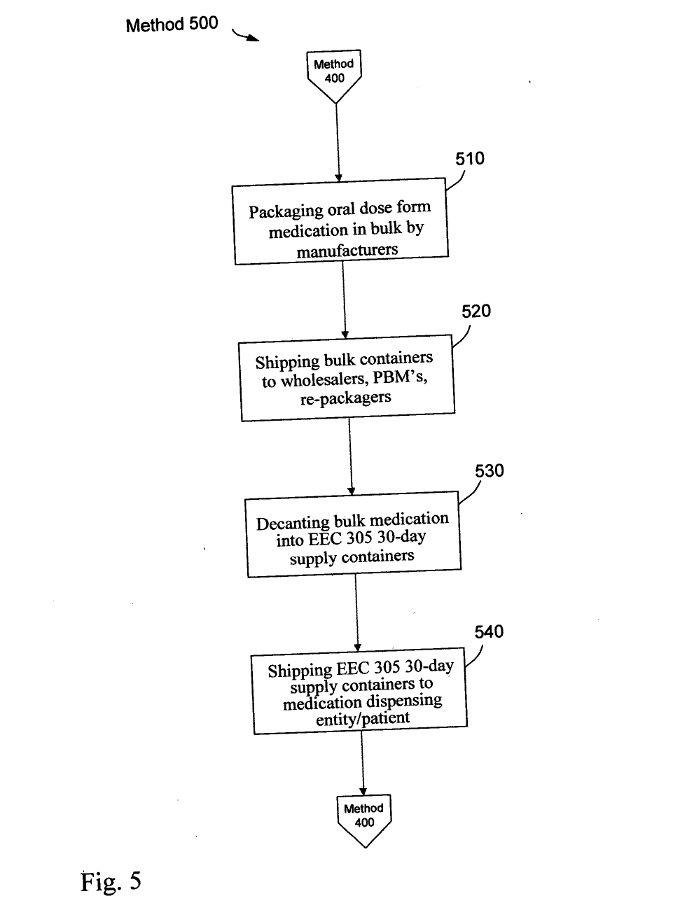

FIG. 5 illustrates Method 500, which describes an alternate medication distribution method in more detail than the method steps 450 through 490 of Method 400 and includes the following steps:

Step 510 Packaging Oral Dose Form Medication in Bulk by Manufacturers

In Step 510, oral dose form medication is packaged by manufacturers in bulk containers for shipment, usually 90 to 5,000 doses. Method 500 proceeds to Step 520.

Step 520 Shipping Bulk Containers to Wholesalers, PBM'S, and Re-packagers.

In Step 520, bulk containers filled in step 510 are shipped to wholesalers, PBM's, and re-packagers. Method 500 proceeds to Step 530.

Step 530 Decanting Bulk Medication into EEC 305 30-day-supply Containers

In Step 530, supply chain stakeholders such as wholesalers, PBM's, and re-packagers decant oral dose forms from bulk into EEC 305. Method 500 proceeds to Step 540.

Step 540 Shipping EEC 305 to Medication Dispensing Entity/patient

In Step 540, EEC 305's filled in Step 530 are shipped to the dispensing entity, most commonly a retail pharmacy, and may include a PBM who may ship EEC 305's directly to patients. Method 500 ends.

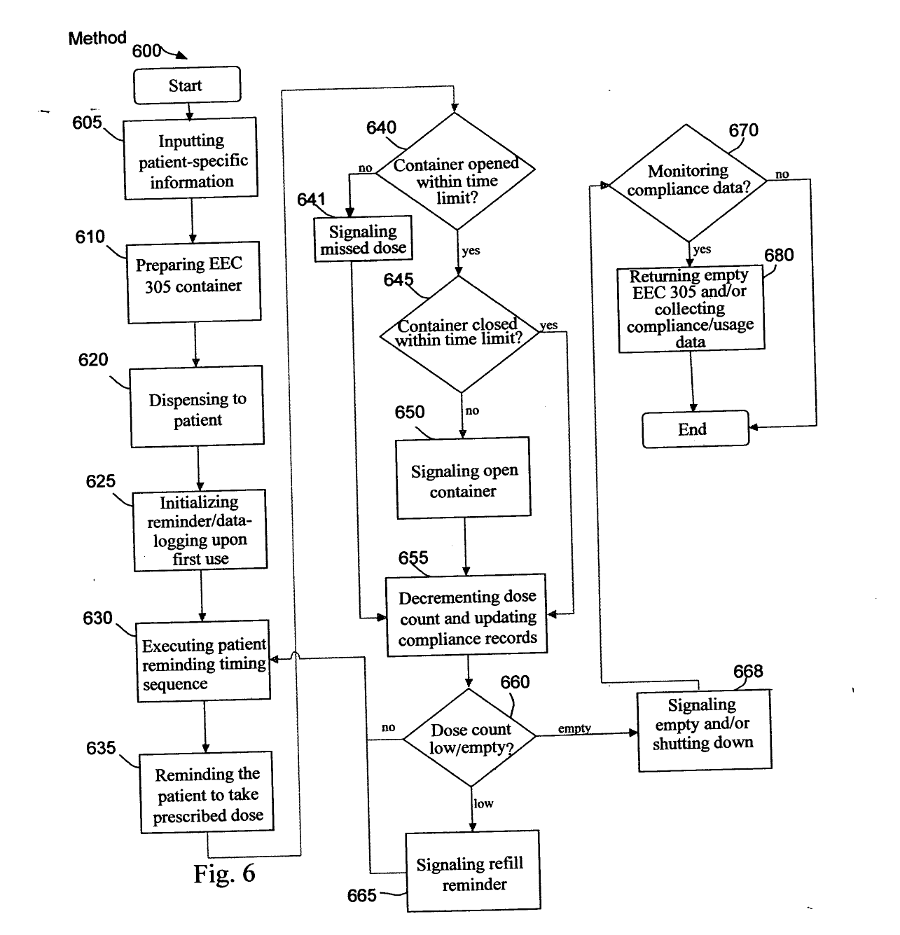

FIG. 6 illustrates Method 600, which describes in more detail the preferred embodiment of the method steps 450 through 490 of Method 400 and includes the following steps:

Step 605 Inputting Patient-specific Information

In step 605, patient-specific information is input into prescription station 320 on site of the medication dispensing entity, including whether compliance will be monitored. Patients may specify whether compliance will be monitored and if so where such data may be shared. Method 600 proceeds to Step 610.

Step 610 Preparing EEC 305

In Step 610, prescription station 320 prepares EEC 305 for dispensing to the patient. Prescription station 320 prints the appropriate prescription instruction label for EEC 305 and any other instructions required for dispensing. Prescription station 320 also may download appropriate data to the electronic patient-reminder and compliance-data-logging programming to electronics of EEC 305. Data may include such information as dose count (number of doses in the container), dosing regimen, dosage period, date, patient name, number of refills remaining on prescription, and expiration date. Prescription station 320 may be equipped to program reminder type and frequency, including revising programming of EEC 305, such as type of reminders, that may have been performed upstream at the factory or by other supply chain stakeholders, such as wholesalers, PBM's, and re-packagers.

Step 620 Dispensing to Patient

In Step 620, dispensing entity 302 physically conveys EEC 305 to the specific patient. A dispensing entity also may mail or ship medicines in EEC 305 to patients.

Step 625 Initializing Reminder/data-logging on First Use

In Step 625, the microcontroller electronics embedded in EEC 305 monitors the container closure sensor. When the patient opens EEC 305 the first time, the reminder/data-logging processes are initialized. Initial opening of and EEC 305 occurs at the time of day patients prefer or have been directed by a licensed medical professional to take each day's first dose. Initialization also may be performed in Step 610 Method 600 proceeds to Step 630.

Step 630 Executing Patient Reminder-timing Sequence

In Step 630, the microcontroller electronics embedded in EEC 305 executes a reminder timing sequence algorithm such that the duration of the timing corresponds to the prescribed time between doses. Method 600 proceeds to Step 635.

Step 635 Reminding the Patient to Take Prescribed Dose

In Step 635, EEC 305 produces sensory directed output to remind the patient to take the appropriate dose of prescribed medication at the proper time. The sensory directed output may include audible, visual, textual, and vibratory signals. Opening and/or closing EEC 305 terminates the reminder signal. Method 600 proceeds to Step 640.

Step 640 Container Opened Within Time Limit?

In Step 640 the microcontroller electronics embedded in EEC 305 monitors the container closure switch. When the container is opened, EEC 305 proceeds to Step 645. If EEC 305 is not opened within the specified time limit, Method 600 Proceeds to Step 641.

Step 641 Signaling Missed Dose.

In Step 641, EEC 305 electronics sense when such time has passed that a period's dose has been missed and signal missed dose via a sensory directed output including audible, visual, textual, and/or vibratory. Method 600 proceeds to Step 655

Step 645 Container Closed Within Time Limit?

In Step 645 the microcontroller electronics embedded in EEC 305 monitors the container closure sensor/switch mechanism. When the container is closed, EEC 305 proceeds to Step 655. If EEC 305 is not closed within the specified time limit, Method 600 proceeds to Step 650.

Step 650 Signaling: Close Container

In Step 650, an alarm sequence is initiated to alert the patient that EEC 305 container is open and needs to be closed. The alarm sequence produces a sensory directed output (audible, visual, textual, and/or vibratory) that is specific to alarm condition. Method 600 returns to Step 645.

Step 655 Decrementing Dose Count and Updating Compliance Records

In Step 655, the electronically stored count of remaining doses in container EEC 305 is decremented by one. In addition, compliance data such as dose-taken time and date is stored in non-volatile memory of EEC 305. In the event of a missed dose in Step 641, the dose count is not decremented and the absence of the container being opened and closed at dose time is evident in non-volatile memory. Method 600 proceeds to Step 660.

Step 660 Dose Count Low/empty?

In Step 660, the electronically stored count of remaining doses in EEC 305 is compared to a value established for a low dose-count condition, e.g. when about 25% of doses remain. If a low dose count condition does not exist, Method 600 proceeds to Step 630. If a low dose count condition exists, Method 600 proceeds to Step 665. If empty, Method 600 proceeds to Step 668.

Step 665 Signaling Refill Reminder

In Step 665 an enunciator sequence is initiated to alert the patient that the prescription needs to be refilled. The enunciator sequence produces a sensory directed output (audible, visual, textual, and/or vibratory) that is specific to the refill-needed condition. Signaling may continue until no doses remain or until the patient acknowledges the reminder as instructed by the label. Method 600 returns to Step 630.

Step 668 Signaling Empty Container

In Step 668, the electronically stored count of remaining doses in EEC 305 is compared to the number of doses dispensed in step 620. When the value reaches zero, no doses remain, causing EEC 305 to signal empty and/or shut down. Method 600 proceeds to Step 670.

Step 670 Collecting Compliance Data?

In Step 670, if directed in Step 605 that an individual patient's compliance would be monitored, Method 600 proceeds to Step 680. If the decision is no, Method 600 ends.

Step 680 Collecting Empty EEC 305's and/or Collecting Compliance/usage Data

In Step 680, empty EEC 305's are collected for data collection and/or polled for data at remote sites such as patient's homes, caregiver's sites, doctor's office, etc. EEC 305 collection means include patient delivering the empty in person to the dispensing entity, delivering or shipping to a data-collection facility, etc. For incentives to patients, empty EEC 305 may function as a coupon for reduced (or zero) co-payment on their refill, money off other drugstore merchandise, etc. Other patient incentives may include reduction in health insurance premiums.

Once in hand spent EEC 305 data is read at the point of receipt of the empty container and/or at a central data-collection facility to which the container has been relayed from the point of receipt, and/or at a reader placed in patients'/caregivers' homes, and the like A stand-alone or PC-based electronics peripheral device such as a cradle or wand may read the empty container's data by electrical contact or wirelessly, which then may be relayed via WEB or other network to a central database for logging and analysis. Method 600 ends.

Once compliance data has been uploaded, in can be analyzed for insights such as specific patient outcomes, effectiveness of types of reminders for various patient groups, and the like. Patient-specific data also can be share with patients and their licensed medical professionals for insights into, increasing compliance, treatment effectiveness, and the like.

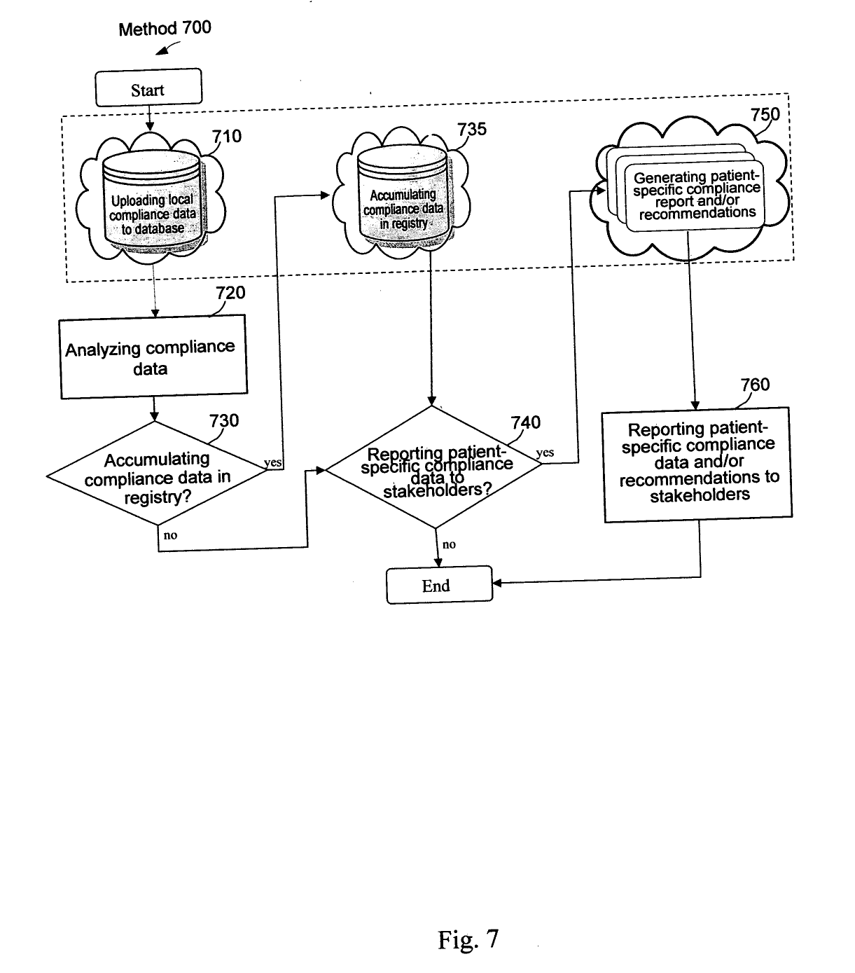

FIG. 7 illustrates Method 700, which describes a method for determining compliance with a dosing regimen and includes the following steps:

Step 710 Uploading Local Compliance Data to Database

In Step 710, refill frequency and date & time of daily dispensing data collected from compliance containers, such as EEC 305, in Step 680 is uploaded to a specified database for analysis via WEB or other network. Method 700 proceeds to Step 720.

Step 720 Analyzing Compliance Data

In Step 720, data uploaded in Step 710 is analyzed for such insights as level of patient compliance, effectiveness of types of reminders for increasing compliance for various patient groups, e.g., elderly, busy executives, and stay-at-home parents. Results and recommendations may be generated, including patient-specific, and non-patent-specific (anonymous) trends, and the like. Analysis also may enable optimization of the types of reminders shown to be most effective for various patient group lifestyles. In fact, reminder-type and other compliance enhancing recommendations can be made specifically for patient age groups. For example, frantically busy business people in their 40's may want distinctively loud and clear alerts like intense LED's and bells, while retired patients are may prefer doorbell-like chimes and/or slow-blinking, dim flashes. Continuously tailoring reminders using EEC 305 usage information for specific patient segments may be expected to continuously improve compliance collectively. Method 700 proceeds to Step 730.

Step 730 Accumulating Compliance Data in Registry?

In Step 730, if patient specified inclusion in a patient registry in Step 605, their compliance data is sent via WEB or other network to Registry 735 for comparison to and analysis among the registry's population. Registry may collect and collate other information, such as treatment outcomes relative to compliance, leading to recommendations and actions by the medical community to improve health-care effectiveness and lower overall health care costs. Registry may include data on effectiveness of reminder type for various patient groups as describe above in Step 720. Method 700 proceeds to Step 740.

Step 740 Reporting Patient-specific Compliance Data to Stakeholders?

In Step 740, if patient specified in Step 605 that compliance data be conveyed to stakeholders such as his/her medical professional, Health insurance company, and the like, Method 700 proceeds to Step 750. If the patient specified in Step 605 that compliance data not be conveyed to such stakeholders, Method 700 ends.

Step 750 Generating Patient-specific Compliance Report.

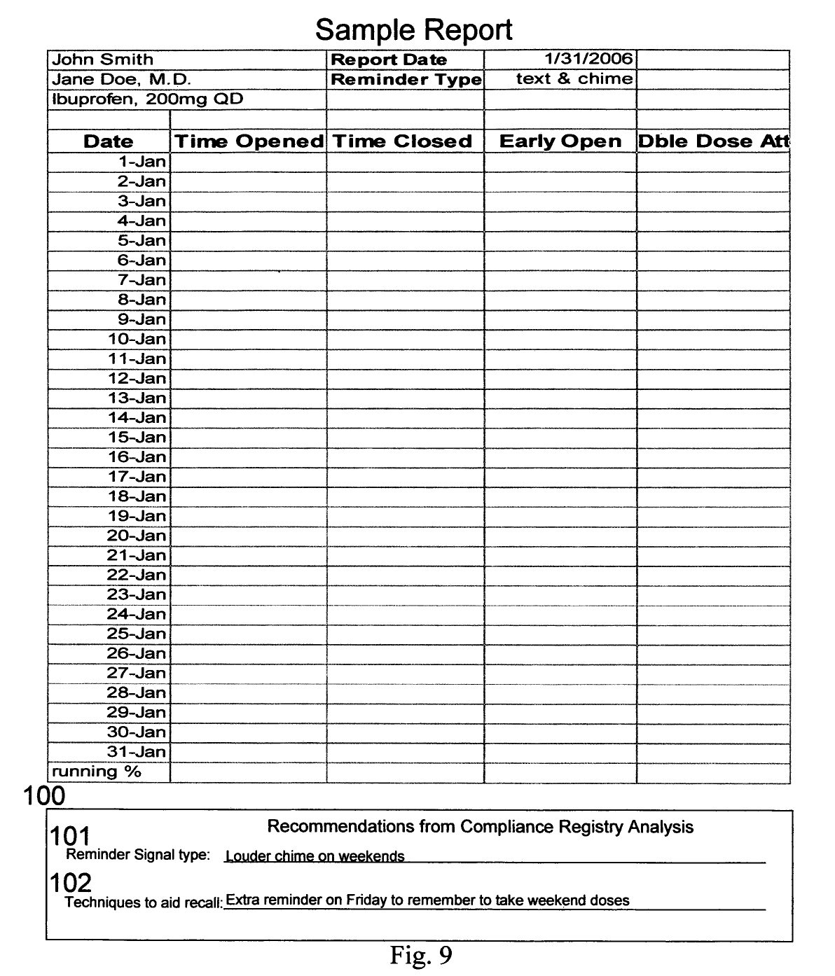

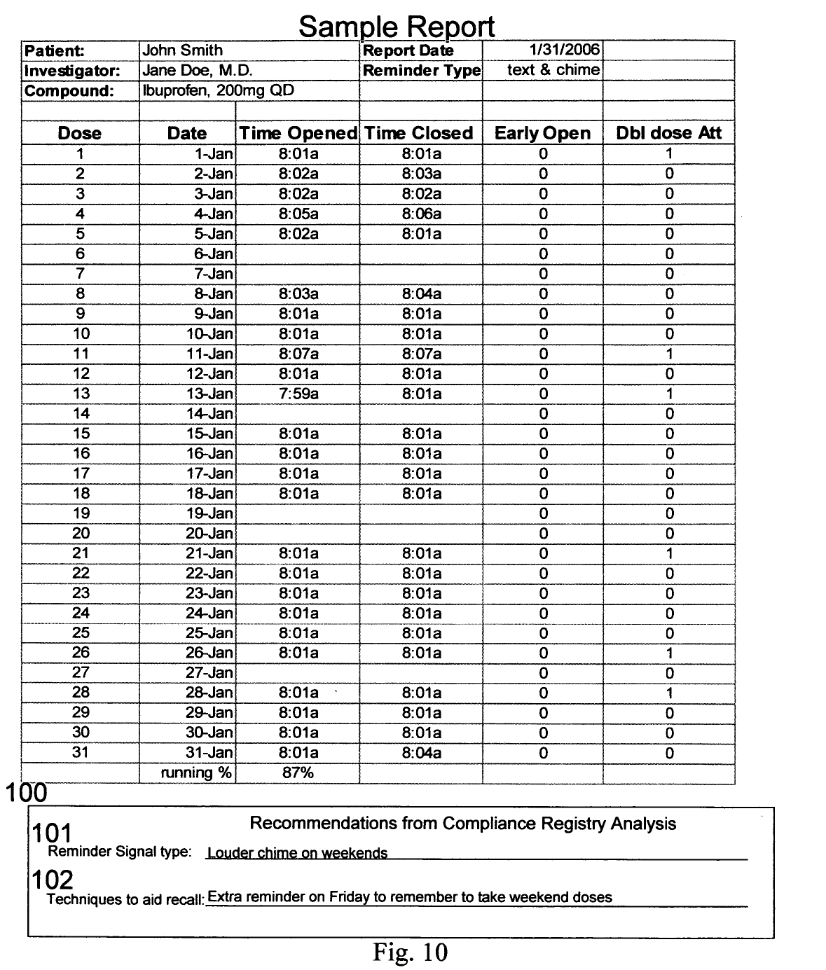

In Step 750, a patient-specific compliance report may be generated from compliance database in Step 710 and analyzed in Step 720 of Method 700 which details such information as patient name, medication name, doctor's name report date, reminder time, date & time of container opening and closing, double dose attempts, percent compliance, and the like. FIG. 9 illustrates the sample report. FIG. 10 illustrates the sample report with select fields populated with examples of data. In the example of FIG. 10, patient John Smith complied January 2006 at a level of 80% The data tell that Patient Smith misses most weekend doses 6, 7, 14, 19, 20, and 27, although he took doses on two Saturdays 13, 26, weekend doses prove a persistent difficulty. Recommendations from Compliance Registry Analysis 100 performed or sponsored by one or more stakeholders such as pharmaceutical manufacturers, HIC's, and others, generate recommendations for Reminder Signal type 101 sounding a louder chime on weekends and Techniques to aid recall 102, providing an extra reminder on Friday to take weekend doses.

Method 700 proceeds to Step 760.

Step 760, reporting patient-specific compliance data and/or recommendations to stakeholders.

In Step 760, the report generated in Step 750 is conveyed via WEB or other network, by mail or other shipment means. The report can be sent via these means to stakeholders such as the patient, caregiver, doctor, and/or health insurance company (HIC) or may be collected by the patient via such means or at such a location as the dispensing entity to take to an appointment with a licensed medical professional, depending on the professional's preferences, and/or for conveyance to HIC. Doctors would use this information such as for assessing therapeutic efficacy of a course of treatment while HICs may be inclined to reward compliance economically such as with reduced deductible payments and co-payments and/or reduction in premium. Returned spent containers may function as coupons redeemable for such financial rewards and/or merchandise at the retail point of container return and/or dispensing. Method 700 ends.

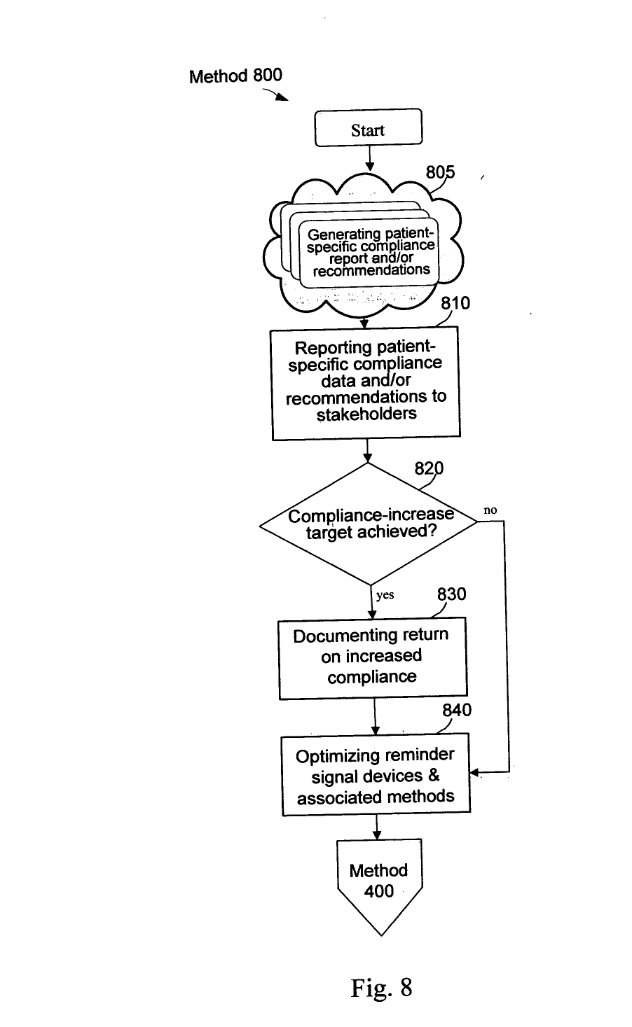

FIG. 8 illustrates Method 800, which describes a method for determining return on investment in compliance reminder signaling devices and related methods, and/or other reminder methods and includes the following steps:

Step 805, Generating Patient Specific Compliance and/or Recommendations

In Step 805 a patient-specific compliance report is generated from compliance database in Step 710. which details information which may be of interest to stakeholders such as patient name, medication name, doctor's name report date, reminder time, date & time of container opening and closing, double dose attempts, percent compliant, and the like. FIG. 9 illustrates the sample report. FIG. 10 illustrates the sample report with select fields populated with examples of data, which is described above in Step 750 of Methiod 700. Method 800 proceeds to Step 810.

Step 810, Reporting Patient-specific Compliance Data and/or Recommendations to Stakeholders.

In Step 810, the report generated in Step 810 and/or in step 760 of Method 700 is conveyed via WEB or other network, by mail or other shipment means, such as DHL, FedEx, and the like. The report can be sent via these means to stakeholders such as the patient, caregiver, doctor, Health Insurance Company (HIC) and/or pharmaceutical manufacturer (PM). PM's may assess this information to inform their choices such as about whether and how much to invest and/or continue investing in increasing patient compliance. This analysis may include such measures as increases in revenue and/or profit from investment in reminder signaling devices and related methods, and/or other compliance-increase methods and/or patient incentives, such as reduction in co-pay, and/or money off other products at the retail dispenser's store. Returned spent containers may function as coupons redeemable for such financial rewards. Method 800 proceeds to Step 820.

Step 820, Compliance-increase Target Achieved?

In Step 820, a decision is made whether the anticipated compliance increase achieves a specific target increase such as 10%. In the case of Lipitor, which generates $10 billion in sales annually, a 10-percent increase would be $1 billion in incremental sales. Other blockbuster drugs, those generating $1 billion or more in annual sales, would generate similarly compelling financial numbers. If the answer is yes, Method 800 proceeds to Step 830 If the answer is no method 800 proceeds to Step 840.

Step 830 Documenting Return on Increased Compliance

In Step 830, stakeholders such as pharmaceutical companies and/or others paying for compliance-increase devices, such as EEC 305, and/or other compliance-increase methods, may document such stakeholders' return on investment in increasing compliance. In the case of Lipitor, which generates $10 billion in sales annually, a 10-percent increase in compliance would generate $1 billion in incremental sales. If each EEC 305 cost $1 and 100 million EEC305 containers would be needed for Lipitor's annual sales volume, the variable cost increase of $100 million for EEDC 305 containers would generate a ten-fold return on investment—far more than the customary investment threshold of one to two-fold returns. Further, such an increase in sales would require none of the ponderous R&D spend for which the pharmaceutical industry is known. Accordingly, such incremental sales increase would be at a higher profit than a new product generating the same revenue increase. Stakeholders such as pharmaceutical companies or HIC's in such circumstances would have information to inform whether to continue making the investment in increasing compliance and/or increasing this investment by turning some portion of the incremental profit back into increasing compliance still further. Method 800 proceeds to Step 840.

Step 840, Optimizing Reminder-type Signal Devices and Associated Methods.

In Step 840, stakeholders such as pharmaceutical companies may analyze patient compliance data gathered and analyzed in Step 720 of Method 700 for such insights into reasons for level of a patient's compliance, effectiveness of types of reminders for increasing compliance for various patient groups, e.g., elderly, busy executives, and stay-at-home parents. Results and recommendations may be generated, including patient-specific, and non-patent-specific (anonymous) trends, and the like. Analysis also may inform optimization of the types of reminders shown to be most effective for various patient group lifestyles. In fact, reminder-type and other compliance enhancing recommendations can be made specifically for patient age groups. For example, frantically busy business people in their 40's may want distinctively loud and clear alerts like intense LED's and bells, while retired patients are may prefer doorbell-like chimes and/or slow-blinking, dim flashes. Continuously tailoring reminders using EEC 305 usage information for specific patient segments may be expected to continuously improve compliance collectively. Method 800 proceeds to Method 400.

6.1 Conclusion

In addition to the features and advantages of the invention explicitly detailed herein, numerous modifications and changes will readily occur to those of ordinary skill in the art upon review of this disclosure. The invention should be understood to include all such limitations. Accordingly, all suitable modifications and equivalents should be considered as falling within the spirit and scope of the invention.

1. A method of continuously increasing patient compliance with medication dosing regimen that does not rely on incremental effort, investment, and/or other patient resource comprising:
a. uploading compliance data from one or more electronically enhanced containers to a database;
b. analyzing said uploaded compliance data;
c. generating one or more patient specific compliance reports from said database; and
d. reporting said one or more patient specific compliance reports to one or more stakeholders.

2. The method of claim 1 wherein said compliance data comprises at least one of the following: frequency, date and time of daily dose dispensing.

3. The method of claim 1 wherein said analysis comprises at least one of the following: level of patient compliance, effectiveness of a specific reminder type.

4. The method of claim 3 wherein said analysis results in a recommendation for a specific type of said reminder type.

5. The method of claim 3 wherein said reminder type comprises one or more or a combination of the following: audible, visual, tactile, textual.

6. The method of claim 1 wherein said compliance data is accumulated in a compliance data registry; wherein said compliance data registry comprises one or more of the following: treatment outcomes relative to compliance, data on effectiveness of reminder type for various patients.

7. The method of claim 1 wherein said stakeholder comprises one or more of the following; a patient, a medical professional, a health insurance company, a pharmaceutical manufacturer, a caregiver, a hospital.

8. The method of claim 1 wherein said one or more patient specific compliance reports comprises one or more of the following: patient name, medication name, doctor's name, report date, reminder time, date and time of container opening and closing, double dose attempts, percent compliance.

9. A method of measuring economic return on investment in increasing patient compliance using compliance reminder signaling devices and related methods, and/or other reminder methods comprising:
a. generating a patient specific compliance report;
b. reporting said patient specific compliance report to one or more stakeholders;
c. determining if patient compliance increase target has been achieved,
d. optimizing type of said reminder signal device; and
e. documenting economic return on increased compliance.

10. The method of claim 9 wherein said patient compliance report comprises: one or more of the following: patient name, medication name, physician's name, report date, reminder time, date and time of container opening and closing, double dose attempts, percent compliant.

11. The method of claim 9 wherein said one or more stakeholders comprise: a patient, a caregiver, a physician, a health insurance company, pharmaceutical manufacturer, hospital.

12. The method of claim 11 wherein said one or more stakeholders analyze said patient compliance report to inform decisions regarding investments into increasing patient compliance.

13. The method of claim 1 wherein said determining if patient compliance increase target has been achieved comprises: whether the anticipated compliance increase achieves a specific target increase.

14. The method of claim 13 wherein said optimizing type of said reminder signal device comprises analyzing said patient specific compliance report for effectiveness of different types of said reminder signal devices for various patient group lifestyles and adjusting said reminder signal devices for said various patient group lifestyle.

15. The method of claim 14 wherein said different types of said reminder signal devices comprises one or more or a combination of the following: visual, audible, tactile, textual.

16. A method of providing economic incentive to a patient comprising:
a. dispensing a prescribed medication in an electronically enhanced container to a patient by a dispensing entity;
b. complying with prescribed medication dosing regimen by said patient;
c. returning spent said electronically enhanced container to said dispensing entity by said patient; and
d. providing an economic incentive to said patient.

17. The method of claim 16 wherein said dispensing entity comprises one or more of the following: a pharmacy, a hospital a dispensary, a pharmacy benefit manager, an authorized entity, a medical professional office, a health insurance company, a medication manufacturer, a medication dispensing entity.

18. The method of claim 16 wherein said economic incentive includes one or more of the following: reduced deductible payments, reduced co-payments, reduce premium payment, coupon.

19. The method of claim 16 wherein said economic incentive is provided by one or more of the following: a pharmacy, a hospital, a dispensary, a pharmacy benefit manager, an authorized entity, a medical professional office, a health insurance company, a medication manufacturer, a medication dispensing entity.
